(19) United States
(12) Patent Application Publication
(10) Pub. No.: US 2022/0114333 A1
(43) Pub. Date: Apr. 14, 2022

(54) WORKBOOKS FOR ONLINE TOOLS

(71) Applicant: salesforce.com, inc., San Francisco, CA (US)

(72) Inventors: Eric WITTKE, Chicago, IL (US); Rick MUÑOZ, Oakland, CA (US); Jon BELKOWITZ, Brooklyn, NY (US)

(73) Assignee: salesforce.com, inc., San Francisco, CA (US)

(21) Appl. No.: 17/070,456

(22) Filed: Oct. 14, 2020

(51) Int. Cl. G06F 40/18; G06F 9/451; H04L 67/306; G06F 3/0483; G06Q 10/10; G06Q 30/02; H04L 67/55; G06F 3/0482; G06Q 10/06

(52) U.S. Cl. CPC G06F 40/18; G06F 9/451; H04L 67/306; G06F 3/0483; G06Q 10/06393; G06Q 30/0201; H04L 67/26; G06F 3/0482; G06Q 10/107

(57) ABSTRACT

Disclosed herein are system, method, and computer program product embodiments for generating and operating workbooks. One embodiment operates by causing display of a workbook having: a first page including a preview of a first object generated by a first online tool; and a second page including a preview of a second object generated by a second online tool. The first page and the second page are displayed simultaneously within the workbook. Then, a command to execute a function against the first object is received, via the workbook, from a user. A request to execute the function is transmitted to the first online tool, where execution of the function generates a revised first object. The embodiment also operates by receiving a revised first page comprising a preview of the revised first object from the first online tool, and replacing the first page in the workbook with the revised first page.

### BACKGROUND

Many online tools exist that generate objects (e.g., reports, spreadsheets, dashboards, applications, pivot tables, etc.) for a user. These objects are based on datasets associated with the user. However, the user is unable to view these objects in a single location and thus the user is unable to execute fully informed decisions based on the entire data landscape from a single location.

### BRIEF DESCRIPTION OF THE DRAWINGS/FIGURES

The accompanying drawings are incorporated herein and form a part of the specification.

FIG. 1 shows a system for generating and operating workbooks in accordance with one or more embodiments.

FIG. 2 shows a flowchart for generating and operating a workbook in accordance with one or more embodiments.

FIG. 3 shows a flowchart for operating a workbook in accordance with one or more embodiments.

FIG. 4 shows a flowchart for processing subscriptions associated with a workbook in accordance with one or more embodiments.

FIG. 5A and FIG. 5B show an example workbook in accordance with one or more embodiments.

FIG. 6 shows an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, method, and/or computer program product embodiments for generating and operating workbooks. Each workbook includes one or more pages and each page corresponds to an object (e.g., spreadsheet, report, dashboard, pivot table, application, etc.) generated by an online tool. The objects are based on one or more datasets pertaining the user. A page may act as a user interface to access the object and/or to issue commands to execute one or more functions against the object. By making multiple pages corresponding to multiple objects available in a single workbook, the user is able to view/access the dataset landscape from a single location. Moreover, the user is able to submit subscription requests to the workbook with conditions/criteria spanning one or more of the objects associated with the workbook, and then receive alerts when those conditions/criteria are satisfied.

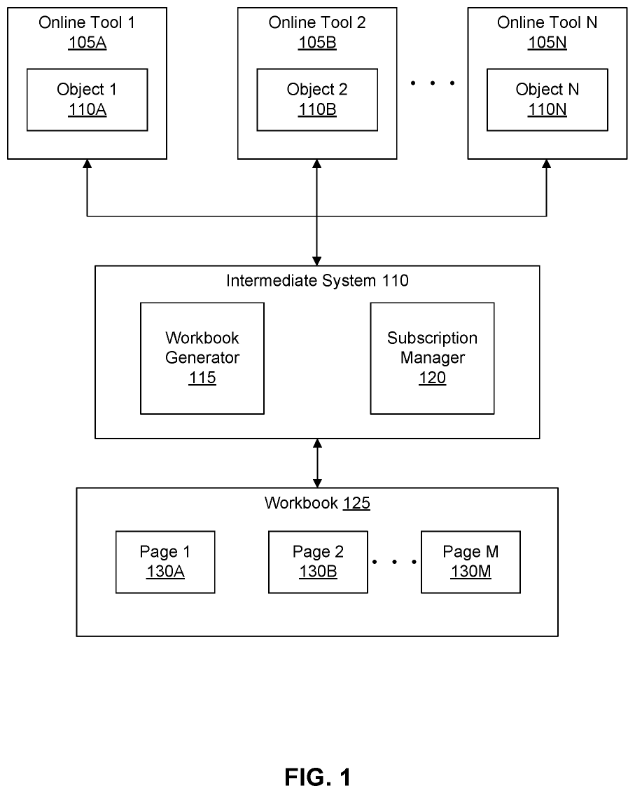

FIG. 1 shows a system for generating and operating workbooks in accordance with one or more embodiments. As shown in FIG. 1, the system has multiple components including, for example, one or more online tools (e.g., online tool 1 105A, online tool 2 105B, online tool N 105N), an intermediate system 110 with a workbook generator 115 and a subscription manager 120, and a workbook 125. Each of these components (105, 110, 115, 120, 125) may execute on one or more computing devices (e.g., server, mainframe, desktop personal computer (PC), laptop, smart phone, tablet PC, etc.) connected by one or more networks having wired and/or wireless segments. Moreover, two or more of the components (105, 110, 115, 120, 125) may execute on the same computing device.

In one or more embodiments, online tools 105 generate objects 110 for a user (e.g., individual, business entity, governmental agency, charitable organization, academic institution, etc.). For example, online tool 1 105A, online tool 2 105B, and online tool N 105N generate object 1 110A, object 2 110B, and object N 110N, respectively. Although FIG. 1 shows each online tool 105 generating one object, in other embodiments, some online tools 105 may generate multiple objects.

Each object 110 may be generated based on the same dataset or different datasets related to the user, the user's website traffic, and/or the user's advertisements. Accordingly, datasets may include, for example, session duration, pages per session, bounce rate etc. of individuals using the website, source of the traffic, impressions, cost-per-thousand impressions (CPM), clicks, cost-per-click (CPC), conversions, e-commerce activity such as transactions and revenue, call history statistics (e.g., number of calls, average duration of calls, frequently called numbers), etc.

In general, each object 110 displays data (e.g., data from a dataset associated with the user). Example objects 110 include reports, spreadsheets, applications, dashboards, pivot tables, etc. Moreover, as discussed below, an online tool may include one or more functions that can be executed against an object to revise the object (e.g., change what is displayed by the object).

In one or more embodiments, the online tools 105 generate pages 130 for objects 110. A page may act as a user interface to access the object and/or to issue commands to execute one or more functions against the object. A page may also include a preview of the object. For example, if the object is a report, the preview may include a graph from the report. If the object is a spreadsheet, the preview may include a subset of cells from the spreadsheet. If the object is an application, the preview may include a main menu of the application. If the object is a dashboard, the preview may include a scaled down version of the dashboard. When an online tool revises an object, the online tool may also generate a revised page including a preview of the revised object. Each page may be given an identifier (e.g., a name).

In one or more embodiments, workbook generator 115 is configured to generate workbooks (e.g., workbook 125) based on one or more objects 110. Specifically, a workbook includes pages 130 for one or more objects 110. For example, workbook 125 includes page 1 130A corresponding to object 1 110A, page 2 130B corresponding to object 2 110B, and page M 130M corresponding to object M (not shown). As shown in FIG. 1, a single workbook may simultaneously display pages for objects generated by different online tools.

In order to generate a workbook, workbook generator 115 may display a list of online tools 105 and/or a list of objects 110 generated by online tools 105. A user may select objects from the one or more lists and the corresponding pages are added to a new or existing workbook. A page may be replaced with a revised page when the corresponding object has been revised. As discussed above, this may be the result of executing a function against the object. Additionally or alternatively, this may be the result of the underlying dataset changing (i.e., the object is based on the dataset).

In one or more embodiments, a user selects a page (e.g., clicks on the page) within workbook 125 to access the corresponding object and/or to issue commands to execute a function against the object. For example, in response to selecting a page, the corresponding object may be displayed in the same or a different window and/or a list of functions that can be executed against the object may be displayed for possible selection. In one or more embodiments, one of the available functions is a global function that can be concurrently executed against two or more objects, possibly all objects, with pages 130 in workbook 125 (discussed below).

One or more of online tools 105 may publish an application programming interface (API). Software external to the online tools 105 (e.g., intermediate system 110) may retrieve objects 110, retrieve pages 130 (e.g., for inclusion in workbook 125), and request one or more functions be executed against objects 110 using API calls. Online tools 105 may also push objects, push revised objects, push pages, and/or push revised pages (e.g., for inclusion in workbook 125) using the APIs. The APIs may be REST APIs and/or webhook APIs (i.e., HTTP push APIs).

Additionally or alternatively, an online tool may provide a uniform resource locator (URL) for a page or an object. In such embodiments, workbook 125 may include an inline frame (iframe) to display the page or object using the URL.

In one or more embodiments, the subscriber manager 120 is configured to monitor one or more of the objects with pages in workbook 125 for criteria/conditions specified in a subscription request from a user. These criteria/conditions may correspond to changes (e.g., +5%) in one or more key performance indicators (KPIs) associated with an object(s). When the criteria/conditions are satisfied, the subscription manager may issue an alert (e.g., email) to the user associated with the subscription request. The subscriber manager 120 may publish all pending subscriptions and their conditions/criteria and/or answer queries regarding the pending subscriptions. Additional details regarding subscription requests are discussed below.

In one or more embodiments, intermediate system 110 may cause workbook 125 to be displayed, may transmit requests to execute functions against objects to online tools 105, and may replace pages in workbook 125 with revised pages following the generation of revised objects. Additional details regarding intermediate system 110 are discussed below.

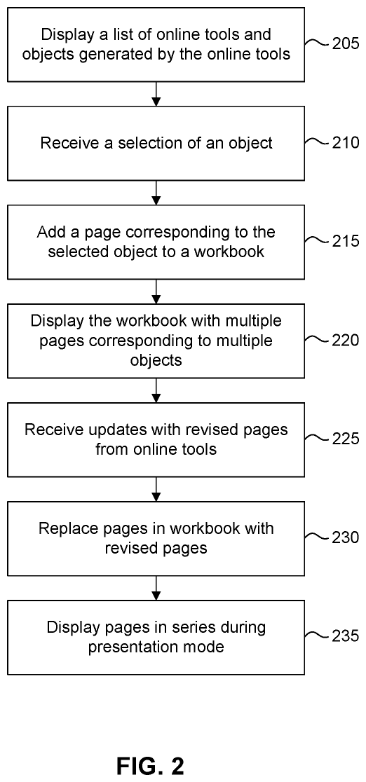

FIG. 2 shows a flowchart for generating and operating a workbook in accordance with one or more embodiments. The steps in FIG. 2 may be executed by one or more of the components discussed above in reference to FIG. 1 (e.g., intermediate system 110, workbook 125). In one or more embodiments, one or more of the steps shown in FIG. 2 may be omitted, repeated, and/or performed in a different order than the order shown in FIG. 2. Accordingly, the scope of the invention should not be considered limited to the specific arrangement of steps shown in FIG. 2. The steps shown in FIG. 2 may be implemented as computer-readable instructions stored on computer-readable media, where, when the instructions are executed, cause a processor to perform the process of FIG. 2

In Step 205, one or more lists are displayed. One list may identify online tools. One list may identify objects generated by one or more online tools. Workbook generator 115 may cause the one or more lists to be displayed in response to a user request to generate a new workbook and/or add a new page to an existing workbook. The lists may have an expandable/collapsible format. In other words, selecting an online tool identified within a first list triggers a second list to be displayed, and the second list identifies the object(s) generated by the selected online tool. In one or more embodiments, the one or more objects generated by an online tool may be determined (e.g., in order to generate the list(s)) by calling an API published by the online tool.

In Step 210, a selection of an object on the list is received from the user. The selection may be received by workbook generator 115. As discussed above, each object displays data (e.g., data from a dataset associated with the user). Example objects include reports, spreadsheets, applications, dashboards, pivot tables, etc.

In Step 215, a page corresponding to the selected object is added to a new or existing workbook. As discussed above, a page may act as a user interface to access the object and/or to issue commands to execute one or more functions against the object. A page may also include a preview of the object. Workbook generator 115 may request the page of the object from the online tool that generates the object. This request may be in the format of an API call to the online tool.

Steps 205, 210, and 215 may be executed multiple times. Following each iteration, a page corresponding to a selected object is obtained from the online tool that generates the selected object, and then added to a new workbook or an existing workbook. In Step 220, the workbook with multiple pages corresponding to different objects is displayed, stored, and/or published online. Moreover, links to the workbook may be transmitted to other users in order for these other users to access the workbook. In one or more embodiments, granting a user access to the workbook automatically grants the user access to the objects with pages in the workbook.

In Step 225, an update with a revised page for one or more of the pages in the workbook is received. The update may be received by workbook generator 115 and from an online tool. The online tool may push the update with the revised page to workbook generator 115. The revised page may reflect a revision to the underlying object by the online tool (e.g., due to changes in the underlying dataset). Accordingly, the revised page may include a preview of the revised object. The online tool may output an update as soon as a revised page is generated. Alternatively, the online tool may output an update at a scheduled time, regardless of when the revised page was generated.

In Step 230, the page in the workbook is replaced with the revised page from the update. The replacement may be executed by workbook generator 115. A page may be replaced with the revised page as soon as the update is received. Alternatively, a page in the workbook might only be replaced with a revised page at specific times (e.g., when no user is viewing the workbook, during a scheduled downtime, during a system update, at midnight, etc.), regardless of when the update with the revised page is received. The page may be replaced with the revised page by workbook generator 115.

In Step 235, the pages of the workbook are displayed as a slide show (e.g., displayed in series) in response to a user request to invoke presentation mode. Specifically, in presentation mode, one page or a subset of the pages are displayed as a slide show. The user progresses to the next page using, for example, the arrow keys on the keyboard, clicking a mouse button, a voice command, etc. For example, if the workbook includes 10 pages, during presentation mode, only one page is displayed at a time and the page is scaled to cover all or most of the display screen. The user moves to the next page by hitting a key. As another example, two pages may be displayed at a time and the subset of pages (i.e., 2 pages) may be scaled to cover all or most of the display screen. The user moves to the next subset of two pages by hitting a key.

Those skilled in the art, having the benefit of this disclosure, will appreciate that by making multiple pages corresponding to multiple objects available in a single workbook, the user is able to view/access the dataset landscape from a single location. Further, in one or more embodiments, the use of pages allows users to preview objects without downloading the entire objects, effectively freeing up network bandwidth and reducing transmission times across the network(s).

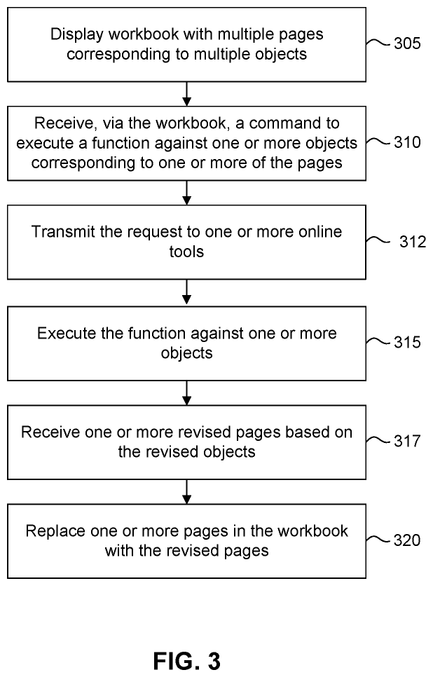

FIG. 3 shows a flowchart for operating a workbook in accordance with one or more embodiments. The steps in FIG. 3 may be executed by one or more of the components discussed above in reference to FIG. 1. In one or more embodiments, one or more of the steps shown in FIG. 3 may be omitted, repeated, and/or performed in a different order than the order shown in FIG. 3. Accordingly, the scope of the invention should not be considered limited to the specific arrangement of steps shown in FIG. 3. The steps shown in FIG. 3 may be implemented as computer-readable instructions stored on computer-readable media, where, when the instructions are executed, cause a processor to perform the process of FIG. 3. One or more steps in FIG. 3 may be executed after one or more steps in FIG. 2.

In Step 305, a workbook with multiple pages corresponding to multiple objects is displayed. Step 305 may be executed after the generation of the workbook or after new pages have been added to the workbook. Alternatively, Step 305 may be executed in response to a request to access an existing workbook. As discussed above, each online tool that generates an object may also make available one or more functions that can be executed against the object. Some functions may be common to multiple objects with pages in the workbook. Such functions may be referred to as global functions. Functions specific to an object may be referred to as local functions.

In Step 310, a command is received to execute a function against an object corresponding to one of the pages. The command may be received by intermediate system 110. The command may be generated in response to the user selecting the page in the workbook and then selecting the function from a list of functions that can be executed against the corresponding object. The list may display both local functions and global functions.

Example local functions may include: deleting a page, editing a page name and URL, duplicating a page (which may include the online tool regenerating the object and providing a new page for the regenerated object), and viewing the object in its native location (e.g., the online tool). If the object is a dashboard, local functions may also include filtering the dashboard and editing the dashboard layout (e.g., allowing the dashboard tiles to be configured). If the object is a pivot table, local functions may include configuring pivot table criteria.

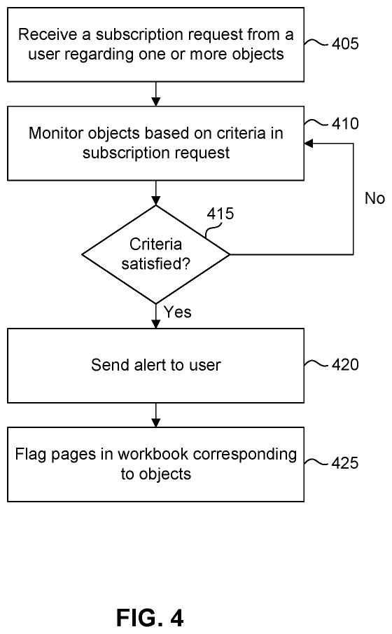

Example global functions may include: filtering the workbook (i.e., filtering all objects with pages displayed in the workbook) for specific measurements or dimensions, searching for instances of a specified text string among all pages, changing the order of pages in the workbook, changing the size/view of the displayed pages in the workbook (e.g., large pages, small pages, list view, etc.), setting alerts/notifications (discussed below in reference to FIG. 4).

In Step 312, a request to execute the function is transmitted to the online tool that generated the object. The request may be generated by intermediate system 110. The request may be a call to an API published by the online tool. In one or more embodiments, the request to execute the function is identical to the received command to execute the function, and thus intermediate system 110 merely relays the command from the workbook to the online tool. Alternatively, intermediate system 110 translates the command into the request and the request has the specific format required by the online tool.

In one or more embodiments, when the command specifies a global function, intermediate system 100 generates and transmits multiple requests to execute the function. The multiple requests are transmitted to the online tools that generated objects with pages in the workbook and that support the function. Each online tool may have different formatting requirements and thus each request generated and transmitted by intermediate system 110 may be in a format specific to an online tool. One or more of these requests may be calls to APIs published by the online tools.

In Step 315, the function is executed against the object. Specifically, the online tool receives the request and then executes the function against the corresponding object. When the function is a global function, Step 315 may be performed by each online tool that receives a request.

As discussed above, executing a function against an object results in a revised object. Each online tool that executed the function against an object may generate a revised page for the corresponding revised object. Each revised page may include a preview of the corresponding revised object. In Step 317, the one or more revised pages are received from the online tools. The revised pages may be received by intermediate system 110. Intermediate system 110 may need to specifically request the revised pages from the online tools. Additionally or alternatively, the online tools may automatically generate and transmit the revised pages following execution of the function to intermediate system 110.

In Step 320, one or more pages in the workbook are replaced with the revised pages. The replacement operation may be executed by intermediate system 110. Each revised page has a preview of the revised underlying object.

The following is a non-limiting example of the process depicted in FIG. 3. Assume there exists a workbook with page A, page B, and page C. Page A corresponds to object A generated by online tool A. Similarly, page B corresponds to object B generated by online tool B, while page C corresponds to object C generated by online tool C.

In this example, when a user accesses (e.g., clicks on) page A within the workbook, the user is presented with a list of functions (function X, function Y) that can be executed against object A. Function X is a local function and thus specific to object A (and thus online tool A), while function Y is a global function and thus common to object A, object B, and object C (and online tool A, online tool B, and online tool C).

If the user selects local function X, through the command/request sequence discussed above, online tool A will execute the function against object A resulting in revised object A. Online tool A will also generate a revised page (“revised page A”) with a preview for revised object A. Page A in the workbook will be replaced with revised page A. The selection of function X will not affect object B or object C, and thus page B and page C in the workbook will remain unchanged.

If the user selects global function Y, through the command/request sequence discussed above, online tool A, online tool B, and online tool C will execute the function against object A, object B, and object C, respectively. This will result in revised object A, revised object B, and revised object C. Online tool A, online tool B, and online tool C will also generate revised pages (i.e., revised page A, revised page B, revised page C). Page A, page B, and page C in the workbook will be replaced with revised page A, revised page B, and revised page C, respectively.

Those skilled in the art, having the benefit of this disclosure, will appreciate that a global function enables the user to execute a function against multiple objects associated with the workbook with a single user-workbook interaction (e.g., selecting the global function from a list). In other words, the user does not need separately access each page and issue a command to execute the function against each object. This is an improvement in GUI design.

FIG. 4 shows a flowchart for processing subscriptions associated with a workbook in accordance with one or more embodiments. The steps in FIG. 4 may be executed by one or more of the components discussed above in reference to FIG. 1. In one or more embodiments, one or more of the steps shown in FIG. 4 may be omitted, repeated, and/or performed in a different order than the order shown in FIG. 4. Accordingly, the scope of the invention should not be considered limited to the specific arrangement of steps shown in FIG. 4. The steps shown in FIG. 4 may be implemented as computer-readable instructions stored on computer-readable media, where, when the instructions are executed, cause a processor to perform the process of FIG. 4. One or more steps in FIG. 4 may be executed after one or more steps in FIG. 2 or FIG. 3.

In Step 405, a subscription request is received from a user. The subscription request may specify criteria corresponding to one or more objects with pages in the workbook. For example, the criteria may require a condition associated with a first object be true and a condition associated with a second object be true. A condition may involve a metric (e.g., key performance indictor (KPI)) of the object satisfying a threshold. For example, the condition may be that a KPI changes by more than 2% (or some other threshold). As another example, the condition may be that a KPI exceeds $1,000,000 or 24 hours or 5000 website clicks or some other threshold, etc. Additionally or alternatively, when the object is an application, the condition may be associated with an algorithm (e.g., algorithm X is completed, algorithm Y returns null, etc.). In one or more embodiments, one or more conditions may involve dates and times (e.g., last Friday of the month, 9:30 am on a Monday, etc.). Subscription requests may be received by subscription manager 120.

In Step 410, the one or more objects associated with subscription requests are monitored based on the criteria. Subscription manager 120 may execute the monitoring. In the case of conditions involving metrics (e.g., KPIs), subscription manager 120 may store previous values of the metrics and then extract new values for these metrics from revised objects. Additionally or alternatively, subscription manager 120 may issue calls to the APIs of the online tools requesting the latest values of the metrics. These calls may be executed with some preset frequency (e.g., every minute, daily, weekly, etc.) or at random. Additionally or alternatively, online tools 105 may push, through webhook APIs, the new values for any of the metrics (or the changes to any of the metrics). These values may be pushed either as soon as they are available or according to a preset schedule (e.g., every minute, daily, weekly, etc.).

In Step 415, it is determined whether the criteria are satisfied. In the case of metrics, this determination may require subscription manager 120 to calculate changes between the latest vales of the metrics and the previous values of the metrics, and then to compare the changes with thresholds. When it is determined that the criteria are satisfied, the process proceeds to Step 420. When it is determined that the criteria are not satisfied, the process returns to Step 410.

In Step 420, an alert is sent to the user associated with the subscription request. The alert may be send by email or SMS. The alert may include a copy of the pages for the objects associated with the criteria. The alert may also include a link to access the workbook.

In Step 425, the pages for the objects associated with the satisfied criteria may be flagged (e.g., highlighted, made larger, animated, changes in colors, changes in shading, background effects, etc.) the next time the user views the workbook. The flagging will easily and quickly remind the user that the criteria have been satisfied and the user should access the object(s) through their pages.

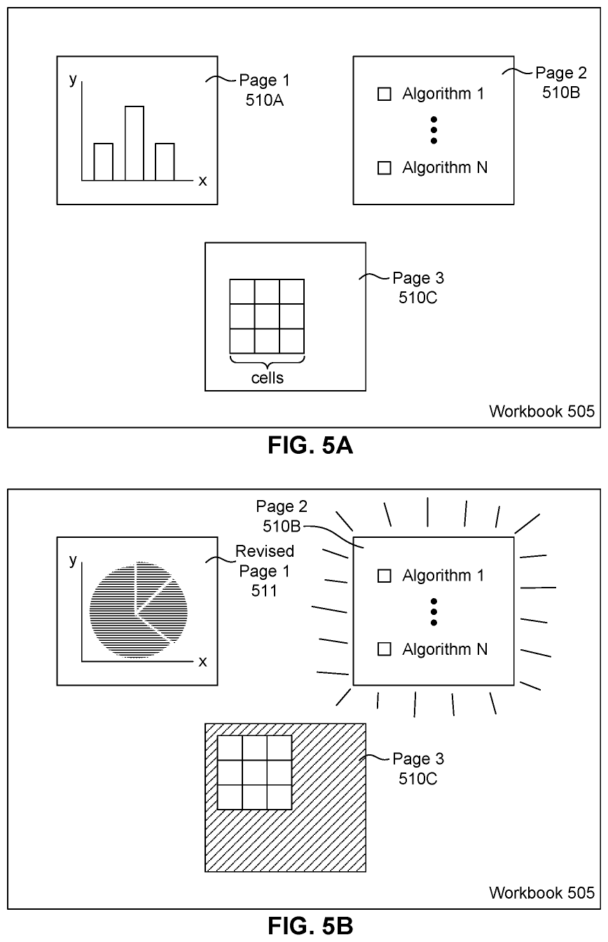

FIG. 5A and FIG. 5B show an example in accordance with one or more embodiments. Specifically, FIG. 5A shows workbook 505 with multiple pages: page 1 510A, page 2 510B, and page 3 510C. Each of the pages 510 corresponds to an object generated by a different online tool (not shown). Page 1 510A corresponds to a report, page 2 510B corresponds to an application, and page 3 510C corresponds to a spreadsheet. As shown in FIG. 5A, page 1 510A includes a bar chart. The bar chart is content from the underlying object (i.e., report). The bar chart acts as a preview for the underlying report. Page 2 510B includes a main menu listing multiple algorithms from the underlying object (i.e., application). The main menu acts as a preview for the underlying application. Page 3 510C includes a subset of cells from the underlying object (i.e., spreadsheet). The subset of cells acts as a preview for the underlying spreadsheet.

Still referring to FIG. 5A, assume a subscription request is received from a user. Specifically, the user wishes to be notified when the following two conditions are true: (1) algorithm N of the application object (associated with page 2 510B) is executed; and (2) one of the cells of the spreadsheet object (associated with page 3 510C) exceeds $1,000,000.

Assume at a future time both condition (1) and (2) are true. Further, assume that the online tool responsible for generating the report (associated with page 1 510A) has revised the report by changing the bar chart in the report to a pie chart, and then issued an update with a revised page including the pie chart as the preview for the revised report.

FIG. 5B shows the workbook 505 at this future time. As shown in FIG. 5B, page 1 A 510A in workbook 505 has been replaced with revised page 1 511. Moreover, revised page 1 511 includes the pie chart as a preview for the revised report. As also shown in FIG. 5B, page 2 510B and page 3 510C are flagged to show the conditions associated with the underlying objects (i.e., application and spreadsheet) are true. An alert in the form of an email with page 2 510B and page 3 510C may be sent to the user associated with the subscription request.

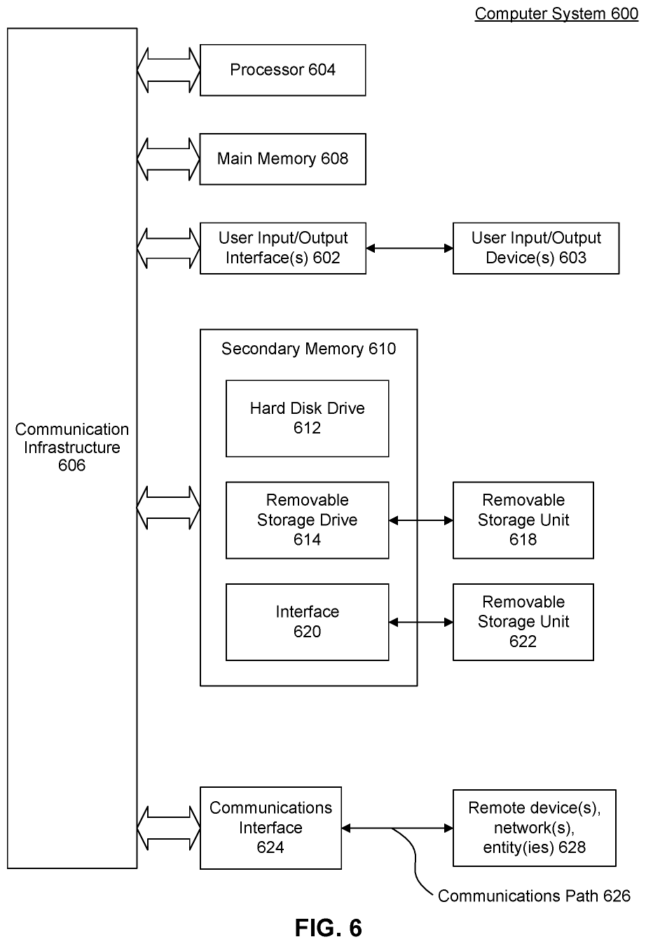

Various embodiments can be implemented, for example, using one or more computer systems, such as computer system 600 shown in FIG. 6. Computer system 600 can be used, for example, to implement the processes shown in FIG. 2, FIG. 3, and/or FIG. 4. Computer system 600 can also be used to implement the workbook shown in FIG. 5A and FIG. 5B. Computer system 600 can be any computer capable of performing the functions described herein.

Computer system 600 includes one or more processors (also called central processing units, or CPUs), such as a processor 604. Processor 604 is connected to a communication infrastructure or bus 606.

One or more processors 604 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 also includes user input/output device(s) 603, such as monitors, keyboards, pointing devices, etc., that communicate with communication infrastructure 606 through user input/output interface(s) 602.

Computer system 600 also includes a main or primary memory 608, such as random access memory (RAM). Main memory 608 may include one or more levels of cache. Main memory 608 has stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 includes a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 reads from and/or writes to removable storage unit 618 in a well-known manner.

According to an exemplary embodiment, secondary memory 610 may include other means, instrumentalities or other approaches for allowing computer programs and/or other instructions and/or data to be accessed by computer system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired and/or wireless, and which may include any combination of LANs, WANs, the Internet, etc. Control logic and/or data may be transmitted to and from computer system 600 via communication path 626.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method, comprising:
causing display of a workbook comprising:
a first page comprising a preview of a first object, wherein the first object is generated by a first online tool; and
a second page comprising a preview of a second object, wherein the second object is generated by a second online tool,
wherein the first page and the second page are displayed simultaneously within the workbook;
receiving, via the workbook and from a user, a command to execute a function against the first object;
transmitting a request to execute the function against the first object to the first online tool, wherein execution of the function against the first object generates a revised first object;
receiving a revised first page comprising a preview of the revised first object from the first online tool; and
replacing the first page in the workbook with the revised first page comprising the preview of the revised first object.

2. The method of claim 1, further comprising:
transmitting, in response to the command, a request to execute the function against the second object to the second online tool,
wherein the function is a global function, and
wherein execution of the function against the second object generates a revised second object;
receiving a revised second page comprising a preview of the revised second object from the second online tool; and
replacing the second page in the workbook with the revised second page comprising the preview of the revised second object.

3. The method of claim 1, further comprising:
receiving an update comprising a revised second page for the second object from the second online tool; and
replacing the second page in the workbook with the revised second page.

4. The method of claim 1, further comprising:
receiving, via the workbook, a request to invoke presentation mode; and
causing the first page and the second page to display in series based on the request to invoke presentation mode.

5. The method of claim 1, further comprising:
receiving a subscription request from a user comprising a first criterion associated with the first object and a second criterion associated with the second object;
determining the first criterion and the second criterion are satisfied; and
sending an alert comprising the first page or the second page to the user based on determining the first criterion and the second criterion are satisfied.

6. The method of claim 1, further comprising:
receiving a selection of a third online tool;
displaying a list of objects generated by the third online tool;
receiving a selection of a third object from the list; and
causing a third page corresponding to the third object to be displayed in the workbook simultaneously with the first page and the second page.

7. The method of claim 1, further comprising:
receiving a URL corresponding to a third object generated by a third online tool; and
causing a third page to be displayed in the workbook simultaneously with the first page and the second page, the third page comprising an inline frame specifying the URL corresponding to the third object.

8. The method of claim 1, wherein the first object comprises a spreadsheet and the second object comprises a dashboard.

9. The method of claim 1, wherein the first object comprises an application.

10. A system, comprising:
a memory; and
at least one processor coupled to the memory and configured to:
cause display of a workbook comprising:
a first page comprising a preview of a first object, wherein the first object is generated by a first online tool; and
a second page comprising a preview of a second object, wherein the second object is generated by a second online tool,
wherein the first page and the second page are displayed simultaneously within the workbook;
receive, via the workbook and from a user, a command to execute a function against the first object;
transmit a request to execute the function against the first object to the first online tool, wherein execution of the function against the first object generates a revised first object;
receive a revised first page comprising a preview of the revised first object from the first online tool; and
replace the first page in the workbook with the revised first page comprising the preview of the revised first object.

11. The system of claim 10, wherein the processor is further configured to:
transmit, in response to the command, a request to execute the function against the second object to the second online tool,
wherein the function is a global function, and
wherein execution of the function against the second object generates a revised second object;
receive a revised second page comprising a preview of the revised second object from the second online tool; and
replace the second page in the workbook with the revised second page comprising the preview of the revised second object.

12. The system of claim 10, wherein the processor is further configured to:
receive an update comprising a revised second page for the second object from the second online tool; and
replace the second page in the workbook with the revised second page.

13. The system of claim 10, wherein the processor is further configured to:
receive, via the workbook, a request to invoke presentation mode; and
cause the first page and the second page to display in series based on the request to invoke presentation mode.

14. The system of claim 10, wherein the processor is further configured to:
receive a subscription request from a user comprising a first criterion associated with the first object and a second criterion associated with the second object;
determine the first criterion and the second criterion are satisfied; and
send an alert comprising the first page or the second page to the user based on determining the first criterion and the second criterion are satisfied.

15. The system of claim 10, wherein the processor is further configured to:
receive a URL corresponding to a third object generated by a third online tool; and
cause a third page to be displayed in the workbook simultaneously with the first page and the second page, the third page comprising an inline frame specifying the URL corresponding to the third object.

16. A non-transitory computer readable medium (CRM) having instructions stored thereon that, when executed by at least one computing device, cause the at least one computing device to perform operations comprising:
causing display of a workbook comprising:
a first page comprising a preview of a first object, wherein the first object is generated by a first online tool; and
a second page comprising a preview of a second object, wherein the second object is generated by a second online tool,
wherein the first page and the second page are displayed simultaneously within the workbook;
receiving, via the workbook and from a user, a command to execute a function against the first object;
transmitting a request to execute the function against the first object to the first online tool, wherein execution of the function against the first object generates a revised first object;
receiving a revised first page comprising a preview of the revised first object from the first online tool; and
replacing the first page in the workbook with the revised first page comprising the preview of the revised first object.

17. The non-transitory CRM of claim 16, the operations further comprising:
transmitting, in response to the command, a request to execute the function against the second object to the second online tool,
wherein the function is a global function, and
wherein execution of the function against the second object generates a revised second object;
receiving a revised second page comprising a preview of the revised second object from the second online tool; and
replacing the second page in the workbook with the revised second page comprising the preview of the revised second object.

18. The non-transitory CRM of claim 16, the operations further comprising:
receiving an update comprising a revised second page for the second object from the second online tool;
replacing the second page in the workbook with the revised second page;
receiving, via the workbook, a request to invoke presentation mode; and
causing the first page and the second page to display in series based on the request to invoke presentation mode.

19. The non-transitory CRM of claim 16, the operations further comprising:
receiving a subscription request from a user comprising a first criterion associated with the first object and a second criterion associated with the second object;
determining the first criterion and the second criterion are satisfied; and
sending an alert comprising the first page or the second page to the user based on determining the first criterion and the second criterion are satisfied.

20. The non-transitory CRM of claim 16, the operations further comprising:
receiving a URL corresponding to a third object generated by a third online tool; and
causing a third page to be displayed in the workbook simultaneously with the first page and the second page, the third page comprising an inline frame specifying the URL corresponding to the third object.
